(19) United States
(12) Patent Application Publication
(10) Pub. No.: US 2005/0160850 A1
(43) Pub. Date: Jul. 28, 2005

(54) Cone ring transmission

(76) Inventor: Matthias Reisch, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/031,939

(22) Filed: Jan. 7, 2005

(30) Foreign Application Priority Data
Jan. 24, 2004 (DE) 10 2004 003 721.3

(51) Int. Cl. F16H 3/38

(52) U.S. Cl. 74/340

(57) ABSTRACT

A cone ring transmission having two rotating cones, a primary cone and a secondary cone, disposed opposite each other upon two shafts and one ring surrounding one of the cones which the contact for producing the frictional engagement is, in addition, to torque dependent at least ratio dependent.

According to the preamble of claim 1, this invention concerns a cone ring transmission having two cones, one primary cone and one secondary cone, disposed opposite each other upon two shafts and rotating and one ring engaged with both cones and surrounding one of the cones.

EP 878 641 has disclosed a continuously variable cone friction ring transmission which has two cone friction wheels situated on parallel axes at radial distance from each other and having equal angles of taper. Filling the intermediate space between the cone friction wheels, one friction ring is situated surrounded by one of the cone wheels and is held in one cage.

The cage comprises one chassis formed by two cross beams and two parallel axles and accommodated therein. One variable bridge is disposed upon the axles with guide rollers which engage on both sides of the friction ring giving it the needed axial guidance. The cage, in turn, is pivotable around one vertical axis of rotation, which axis of rotation lies in the plane determined by the axes of rotation of the friction cone wheels. When the cage is pivoted around a small angle of taper, the frictional drive produces an axial adjustment of the variable bridge and therewith a change of the reduction ratio of the cone friction wheels.

According to said publication, such a cone ring transmission is especially adequate for the front drive of a motor vehicle which has a hydraulic converter or a fluid clutch, one shift unit rear-mounted on the latter for the cone friction ring transmission and one output. The output part of the fluid clutch sits here upon one shaft upon which is situated one electronically controlled brake disc. Behind the brake disc, a free-wheeling gear wheel is provided, which is engaged with a gear reduction unit and on the output can produce the reverse gear. On one side, the gear wheel has a crown toothing with which it is brought to engage with a gear change sleeve held upon the shaft and having an axially displaceable internal toothing and it can be activated.

Therefore, the cone friction ring transmission consists of two opposite cone friction wheels disposed at radial distance from each other with equal angle of taper and parallel axes. The cone friction wheel, the primary cone, connected with the input shaft is surrounded by the friction ring which, by its inner surface, is in frictional engagement with the primary cone and by its outer surface with the cone friction wheel, the secondary cone, connected with the output shaft.

One other cone friction ring transmission and a method for regulating the reduction ratio has been described in EP 980 993. This known cone friction ring transmission has, likewise, two cone friction wheels opposite each other and disposed on parallel axes and one friction device operatively connecting the two cone friction wheels, but upon the friction device acts one torque with a component which stands perpendicularly on a plane determined by both cone friction axes. The friction device can be displaced by way of a guide along the cone friction wheels and is shaped so as to be pressed with a torque against the guide. Since the friction device is subject to stress, it is thus possible to minimize the danger of oscillation of the transmission.

In one concrete configuration, the friction device is situated between the cone friction wheels and has a first running range which rolls on the first of the two cone friction wheels and a second running range which rolls on the second of the two cone friction wheels. Both running ranges are disposed offset relative to a plane of rotation of the friction device which is situated perpendicular to an axis of rotation of the friction device. Accordingly, both running ranges are at different distances from the plane of rotation.

The reduction ratio in the known cone friction ring transmissions is adjusted according to the relative position of the encircling friction element; it being possible to change the relative position of the friction element by changing a rotation position relative to an axis. The rotation position of the friction element is used as adjusting parameter for the regulation. This position of rotation can be changed by turning the chassis or the guide rods for the chassis. In one concrete embodiment, according to this publication, the reduction ratio is regulated by providing rotational speed meters both on the input shaft and on the output shaft. As regulation parameter serves the rotational speed ratio between the two shafts, the rotational speed ratio being regulated via the position of rotation of the friction ring. If the measured rotational speed ratio diverges from the desired rotational speed ratio, a change of position of the friction ring is produced. Thereby the latter shifts along the surfaces of the cone friction wheels until reaching the desired rotational speed ratio at which a corresponding change of rotation position of the friction ring is effected so that the latter is again aligned parallel with the cone friction ring axes.

Hydraulic means are also provided which load at least one cone friction wheel with an axially oriented force pointing from cone stump to cone peak. Thereby the stress between the cone friction wheels and the friction device can be controlled. This control can be effected depending on a load but also depending on a selected acceleration or a velocity. The hydraulic means have a stamp adjustable in axial direction relative to the cone friction wheel. It should also be possible to provide mechanical means, especially plate springs, which make a force loading possible and exert an axial initial stress upon the cone friction wheel.

DE 101 50 317 describes a continuously variable reduction gear transmission, a so-called CVT transmission, which has a first disc set and a second disc set, the same as one belt drive by means of which a torque can be transmitted between the disc sets. One hydraulic system is further provided which loads at least one of the disc sets and one shift mechanism which changes the input energy flow to the pump.

The pump interacts with a torque feeler in order to load at least one disc set or both disc sets of the continuously variable reduction gear transmission. Means are also provided to adjust the ratio of the continuously variable reduction gear transmission, the load of one disc set being controlled either independently of or depending on the other disc set.

To maintain an adjusted ratio upon the respective disc sets one load in axial direction is applied which depends on the torque to be transmitted between the disc sets and/or on the adjusted ratio and being accordingly controlled. This load brings about that the friction forces given between the belt drive means and the respective disc set suffice for transmitting the respective torque to be transmitted between the disc sets. For this purpose, the means for maintaining the ratio have a torque feeler which, depending on a torque on the output side and depending on the ratio adjusted in the continuously variable reduction gear transmission, produces on the output side a force with which the respective disc set is loaded.

In both cone ring transmissions mentioned above, the contact pressure for producing the frictional engagement is generated via a ball-ramp system. The secondary cone produces, in proportion to the output torque of the cone, connected with the output shaft, an axial force which generates, on the ring contact points, the normal pressure needed for the frictional engagement.

The ball-ramp system for the ratio critical for slipping has to be laid out “high” which in a “low” ratio results in an over tightening substantially corresponding to a factor of 2 to 2.5. This disadvantage becomes significant directly upon the layout since at the ratio “low”, very high pressure values already appear which are determinant for the durability of the cone ring transmission.

The problem on which this invention is based is to provide a cone ring transmission of small size and with an optimal degree of efficiency. Besides, the inventive transmission is to be produced at reasonable cost.

This problem is solved by the features of claim 1. Other developments and advantages result from the sub-claims.

A cone ring transmission is proposed which has two rotating cones disposed opposite to each other upon two shafts, one primary cone and one secondary cone and one ring engaged with both cones and surrounding one of the cones wherein the contact pressure in addition to being torque dependent, is at least ratio dependent.

Within the scope of another alternative of the invention, it is provided that the contact, between the two cones, be dependent on other parameters, such as the temperature and/or the input rotational speed and/or the output rotational speed.

To achieve a dependence of the contact on the ratio, it is proposed within the scope of a specially advantageous development of the invention to arrange the axial position of one cone dependent on the ratio.

It can here be provided that both cones have different angles of taper. Alternatively, the cones can diverge from the specific cone shape and have a convex or concave surface. Within the scope of one other embodiment, it can be provided that the axes of both cones are not disposed parallel with each other.

If the axial cone position is ratio dependent, it is possible by a non-linear path-dependent ball-ramp system to implement a contact that is both proportional to the transmitted torque and also dependent on the adjusted ratio.

Within the scope of another preferred embodiment, it is proposed to achieve a dependence of the contact on the ratio by means of the geometric configuration of the cones, in which case, no change of the ramp outline is needed. For this purpose, the primary cone can preferably be designed convex and the second cone concave.

The invention is explained in detail herebelow with reference to the drawing where several advantageous embodiments are shown. In the drawing the figures show:

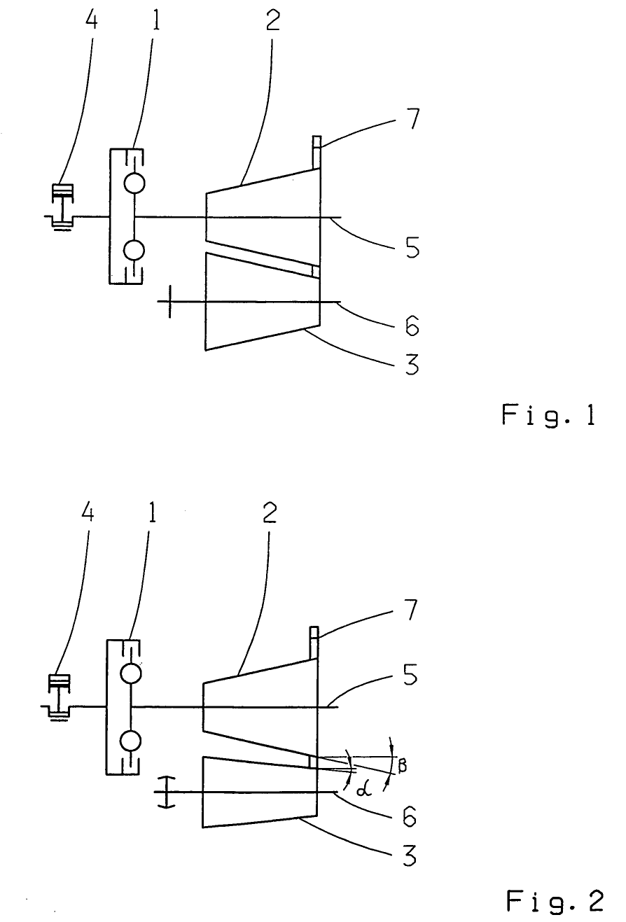

FIG. 1 is a diagrammatic construction of a conventional cone ring transmission;

FIG. 2 is a first embodiment of an inventive cone ring transmission;

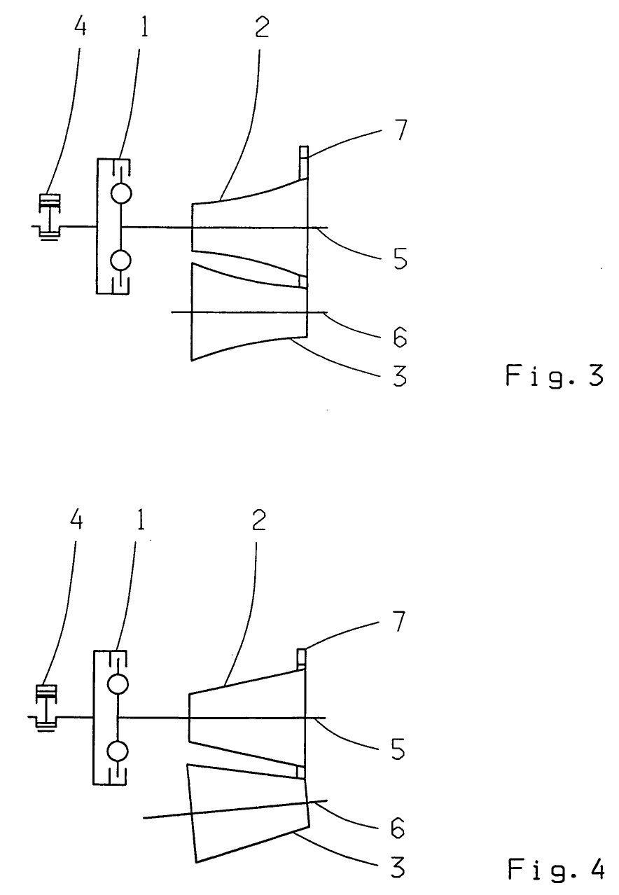

FIG. 3 is a second embodiment of an inventive cone ring transmission;

FIG. 4 is a third embodiment of an inventive cone ring transmission;

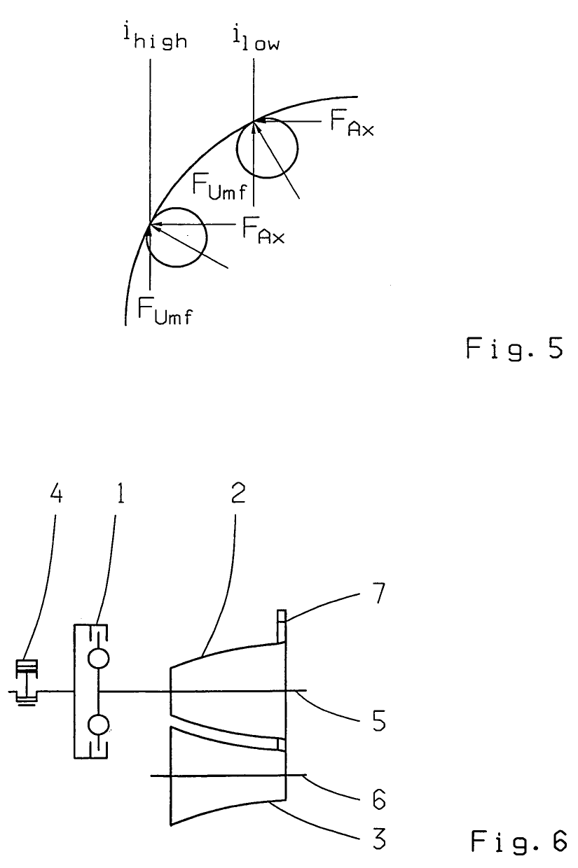

FIG. 5 is a diagrammatic graph of a ramp shape according to the invention; and

FIG. 6 is one other embodiment of an inventive cone ring transmission.

In FIG. 1 a conventional cone ring transmission is diagrammatically shown, connectable via one clutch 1 with an engine 4 of a motor vehicle. The cone ring transmission has a primary cone 2 and a secondary cone 3, the primary cone 2 being surrounded by a ring 7. With 5 is designated the axis of the primary cone 2 and with 6 the axis of the secondary cone 3, both axes 5 and 6 being disposed parallel with each other.

FIG. 2 shows a first inventive embodiment wherein the same parts have been provided with the same numerals. In this embodiment, both cones, i.e., the primary cone 2 and the secondary cone 3, have different angles of taper α and β in order to achieve the desired ratio dependence of the axial position of one of the two cones.

In the embodiment shown in FIG. 3, where the same parts have been provided with the same numerals, the surface of both cones is designed concave to achieve the ratio dependence of the axial position of one of the two cones.

In the embodiment shown in FIG. 4, both axes 5, 6 of the primary cone 2 and of the secondary cone 3 are disposed relative to each other forming a small angle not equal to zero, i.e., no longer parallel with each other.

In all the inventive embodiments shown, it is possible to implement a contact by a non-linear path-dependent ball-ramp system which, in addition to torque dependence, has a ratio dependence.

Such a ramp shape is the object of FIG. 5. Due to the ramp shape, observed at constant output torque in which the ratio is geared up i_high, a contact pressure F_Ax is exerted which is considerably stronger than the contact pressure F_Ax in the geared down i_low. F_umf designates the peripheral force.

In FIG. 6 is shown an embodiment in which a dependence of the contact on the ratio is achieved by the geometric configuration of the cones. The primary cone 2 is designed convex and the secondary cone 3 concave.

By virtue of the inventive idea, a slight overpressure is advantageously obtained which results in smaller dimensions, saving in cost and improvement in efficiency degree of the cone ring transmission.

This invention is utilizable not only for a cone ring transmission having two rotating cones disposed opposite to each other upon two shafts, but also for a transmission containing two axially symmetrical bodies instead of cones.

Reference numerals

1 clutch

2 primary cone

3 secondary cone

4 engine

5 axis

6 axis

7 ring

1-10. (canceled)

11. A cone ring transmission comprising two rotating cones, a primary cone and a secondary cone, disposed opposite to each other upon two shafts and one ring surrounding one of the cones, a contact, for producing a frictional engagement, is torque dependent and ratio dependent:

12. The cone ring transmission according to claim 11, wherein for ratio dependence of the contact, a non-linear path-dependent ball-ramp system is provided, the axial position of one cone being designed ratio dependent.

13. The cone ring transmission according to claim 12, wherein angles of taper (α, β) of the primary cone (2) and the secondary cone (3) are different.

14. The cone ring transmission according to claim 12, wherein a surface of one of the two cones (3) is convex.

15. The cone ring transmission according to claim 12, wherein a surface of one of the two cones (2) is concave.

16. The cone ring transmission according to claim 12, wherein surfaces of both cones (2, 3) are concave.

17. The cone ring transmission according to claim 12, wherein axes (5, 6) of the primary cone (2) and the secondary cone (3) form a small angle unequal to zero in relation to each other.

18. The cone ring transmission according to claim 11, wherein the ratio dependence of the contact is achieved by geometric configuration of the cones.

19. The cone ring transmission according to claim 18, wherein the primary cone (2) and the secondary cone (3) are designed concave.

20. The cone ring transmission according to claim 11, wherein the contact is dependent on one or more of temperature, an input rotational speed and an output rotational speed.
